(19) United States
(12) Patent Application Publication
(10) Pub. No.: US 2004/0234790 A1
(43) Pub. Date: Nov. 25, 2004

(54) Multi-layered, laminated, high barrier, corrosion inhibiting flexible packaging material

(76) Inventors: William Stuart Smith, Fairport, NY (US); Joseph John D.Sabantonio, Victor, NY (US); Boris Alexander Miksic, St Paul, MN (US)

Correspondence Address: HERITAGE PACKAGING, 400 MASON ROAD, FAIRPORT, NY, 14450, US

(21) Appl. No.: 10/775,686

(22) Filed: Feb. 10, 2004

Related U.S. Application Data
(60) Provisional application No. 60/446,572, filed on Feb. 12, 2003.

(51) Int. Cl. B32B 15/08

(52) U.S. Cl. 428/457

(57) ABSTRACT

A multi-layered (composite) flexible packaging material used to envelop either ferrous or non-ferrous metal assets for the purpose of preventing corrosion during transport or long-term storage and preservation. An aluminum foil (barrier layer) is sandwiched between outer layer(s) of flexible film(s) that provide puncture, abrasion and tear resistance and the inner sealant layer known as Cortec VpCI®-126 film (or its equivalent), which provides the corrosion preventive characteristics of the composite. The foil layer; which provides maximum barrier capacities against the transmission of water vapor and other gasses, prevents the out-gassed corrosion inhibiting VpCI vapor from escaping from within an enclosure while simultaneously preventing the ingress of any external gasses. The composite effectively performs for long periods (numerous years) even in extremely corrosive environments and will maintain a vacuum; further enhancing its value. Significant performance improvement is achieved compared to utilization of non-foil-bearing composites for corrosion prevention.

This specification is now being filed (during the pendency) of the earlier filed Provisional Application having a filing date of Feb. 12, 2003 and which was assigned application Ser. No. 60/446,572, Confirmation No. 3860 and Filing Receipt #OC000000009694186. It is the intent of the inventors to take benefit from said earlier filing.

### FIELD OF THE INVENTION

This invention relates to the protection of metal items from the ill effects of corrosion and more particularly to a flexible packaging material that is a composite made up from several different flexible materials which are arranged in layers; each possessing particular properties that collectively meet the goal of anti-corrosion protection, provided solely by a flexible packaging material, that will provide said protection for extended periods of time.

### BACKGROUND OF THE INVENTION

Previously, products or assets made entirely of metal, or having component parts made from metal have been protected from corrosion through the use of many different methods and /or compounds. Traditional methodologies include the “oiling” of all metal parts, application of grease to metal parts, saturation of parts with corrosion preventative sprays, manual wrapping of parts with corrosion inhibitor impregnated papers, packing parts inside a vapor barrier bag with moisture absorbing desiccants enclosed within and packaging parts inside mono-layered olefin based corrosion inhibiting films. Said methods have achieved limited success due to their dependency upon “operator application consistency” and exposure of packaged items to extreme corrosive environments for extended periods. Additionally; the oils and greases etc. would require an expenditure on subsequent cleaning labor prior to utilization of the product being protected and the methods that do utilize VCIs (volatile corrosion inhibitors) are only effective for short periods of time (less than three months) before the effectiveness of the VCI chemistry has migrated out of the carrier material and dissipated into the atmosphere. This invention demonstrates substantial improvement of corrosion protection techniques through the combination of an effective corrosion inhibiting mono-layered film with a moisture and gas barrier providing foil layer, together with additional “outer-skin” layers of other flexible films that provide tear, abrasion and puncture resistance to the overall composite material. When a metal item is enveloped within a package made from this invention it will be protected for substantially longer periods of time (numerous years) because the VCI chemistry is trapped inside the package as well. The barrier foil layer prevents the corrosion inhibiting molecules from escaping while at the same time preventing any new moisture or corrosive gasses from entering the pack.

### SUMMARY OF THE INVENTION

This invention is a high performance laminated composite structure for use in the protection of both ferrous and non-ferrous metals from damage caused by corrosion, rust or oxidation. The material is manufactured through the utilization of either extrusion, solvent or adhesive lamination processes. After lamination, the material is re-wound onto a core as “Single Wound Sheeting” from which it may be further processed into converted items such as heat sealed bags, covers, liners, continuous tubing, pouches, edge-sealed V-sheeting, die-cut shapes etc. The net result of the utilization of this invention is that the end user will benefit from long-term protection against corrosion and no need for the cleaning of parts prior to their use. The combined barrier and anti-corrosion properties are intended to render the laminated composite structure useful as a flexible packaging material used to protect products during transportation and /or long term storage and preservation.

### DETAILED DESCRIPTION

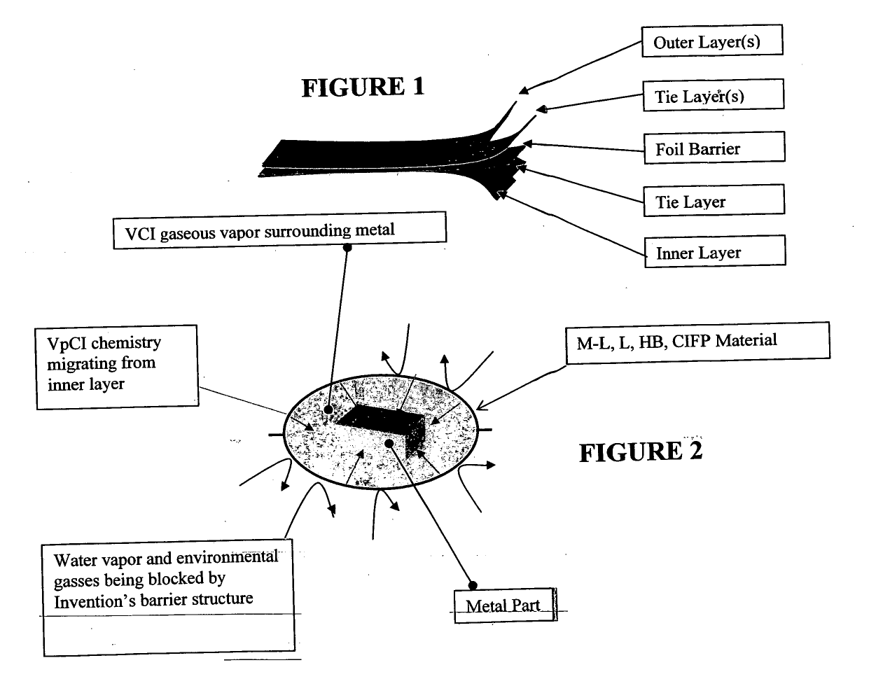

The composite structure is comprised of (an) outer layer(s) of flexible film(s) (such as Polyester, Nylon, TYVEK®, Valeron® Film or Polypropylene etc.). The outer layer(s) provide puncture, abrasion and tear resistance and they enhance the overall strength and barrier capacity of the composite material. A “tie layer” (i.e. polyethylene extrudate, adhesive or solvent); bonds the outer layer(s) (to each other if applicable) and to a Barrier Layer which is an aluminum foil (which is a major improvement over olefin based barrier layers of other structures). The foil layer minimizes the transmission of water vapor, oxygen and other gasses, through the material. This block or barrier works in both directions; thereby keeping desired elements in and un-desired elements out of a package or cover made from the material. Another “tie layer” is used to bond the inner sealant layer to the foil. The inner layer is a LDPE film identified as Cortec VpCI-126 (or its equivalent) The VpCI-126 is a vapor phase corrosion inhibiting film. See FIG. 1 for a graphic depiction of the manner in which the different layers of the composite are assembled.

The volatile corrosion inhibiting chemistry contained within the “sealant layer,” migrates out of the film, on a molecular basis, into the interior atmosphere of the package and surrounds the metal parts enclosed. The VpCI molecules make their way to all metals within a given enclosure and form a microscopic film on the surface of the metal. This film prevents any moisture or corrosive gas that may be present from contacting the metal; thereby preventing corrosion from occurring. The barrier layer (foil) prevents the gaseous vapor phase corrosion inhibiting molecules from escaping from the package thereby trapping the protective chemistry within (See FIG. 2). This entrapment of the VCI chemistry or corrosion inhibiting elements, remains in an un-diminished, full strength condition indefinitely.

The flexibility of all layers of the composite material and the absolute barrier properties provided by the foil layer are what enable the material to maintain a vacuum. It is the combined strength and suppleness of the inner and outer layers that prevent the foil layer from being compromised during the “draw-down” phase of vacuum packaging. The significance of this feature of the invention is great. The complete elimination of any atmosphere from within a package or larger enclosure, such as a three dimensional cover for a large piece of equipment, results in the elimination of any corrosion causing elements from that same environment. After evacuation of the inner atmosphere takes place, the VCI chemistry is still contained within the sealant layer film and will migrate out of that layer and coat the metal parts within the package. In the event of a package under a vacuum condition being punctured during shipment or storage, the VCI coating remains present and at work preventing corrosion from occurring.

1. This multi-layered laminated structure is the first and only flexible packaging material that combines substratum (comprised of one or more strength providing outer layers affixed to an aluminum foil barrier layer), with a vapor phase corrosion inhibiting film used as a sealant layer, to yield a composite material that can be heat-sealed to form an air-tight enclosure around any given metallic asset and that can maintain a vacuum after the atmosphere from within the enclosure has been evacuated. The end result of this combination of flexible materials is a composite, that when heat-sealed, around an item, and without any previous “conditioning” done to the metal, will prevent the occurrence of corrosion on that item.
